(19) United States
(12) Patent Application Publication
(10) Pub. No.: US 2008/0178720 A1
(43) Pub. Date: Jul. 31, 2008

(54) Sawing Installation, and Method For Sawing an Object

(76) Inventor: Stephanus Franciscus Trompert, Den Haag (NL)

Correspondence Address: YOUNG & THOMPSON, 209 Madison Street, Suite 500, ALEXANDRIA, VA, 22314, US

(21) Appl. No.: 11/915,419

(22) PCT Filed: May 24, 2006
(86) PCT No.: PCT/NL2006/050125

§ 371 Date: Jan. 16, 2008

(30) Foreign Application Priority Data
May 26, 2005 (NL) 1029136
Oct. 6, 2005 (NL) 1030133

(51) Int. Cl. B26D 7/06

(52) U.S. Cl. 83/23; 83/162

(57) ABSTRACT

A sawing installation for sawing an object, such as an elongated structural steel section, comprises a sawing bench for at least partially accommodating the object and a saw that comprises a saw blade. The saw blade can move transversely relative to the sawing bench between an initial position in which, when an object has been arranged on the sawing bench, the saw blade is situated at a distance therefrom, and a final position, wherein the saw blade has sawn through said object into the sawing bench. The sawing installation further comprises a feed track that is aligned with respect to the sawing bench. The feed track is provided with a drive member for driving the object over the feed track towards the sawing bench. Furthermore, the sawing installation has a stop for guiding the object while it is being driven. The sawing installation is provided with a guide member for forming a guide channel between the stop and the guide member. The guide channel extends on both sides of the saw blade.

The invention relates to a sawing installation for sawing an object, such as an elongated structural steel section, comprising:

a sawing bench for at least partially accommodating the object,

a saw that comprises a saw blade, which saw blade can move transversely relative to the sawing bench between an initial position in which, when an object has been arranged on the sawing bench, the saw blade is situated at a distance therefrom, and a final position, wherein the saw blade has sawn through said object,

a feed track that is aligned with respect to the sawing bench, which feed track is provided with a drive member for driving the object over the feed track towards the sawing bench, as well as

a stop for guiding the object while it is being driven.

A sawing installation of this type is known. A structural steel section is, for example, an H-shaped, a U-shaped or an L-shaped girder for use in steel construction. Structural steel sections are commercially available in standard lengths of 6, 12 or 24 metres. Such structural steel sections therefore usually have to be cut off to suit customer requirements. By means of the sawing installation, a steel constructor processes the structural steel section to a desired product, i.e. a section part with the desired dimensions.

The drive member of the known sawing installation is made up of a pusher carriage, which transports the structural steel section over the feed track to the sawing bench. For this purpose, the pusher carriage pushes against the rear end of the structural steel section. The front end of the structural steel section then slides onto the sawing bench. With this arrangement the stop provides a reference line or zero line. During its movement the structural steel section remains resting against the stop.

The pusher carriage slides the structural steel section to a set position below the saw. The saw is, for example, a band saw that is fitted above the sawing bench. The band saw then moves downwards to the final position, while carrying out a sawing movement. In the final position the band saw has sawn slightly into the sawing bench, so that the structural steel section is fully sawn through.

The saw can turn about an axis of rotation that runs transversely to the sawing bench. This makes it possible to saw a part of the structural steel section at an angle. The saw cut can therefore be made both essentially perpendicularly and at an angle with respect to the longitudinal direction of the structural steel section.

For the operation of the sawing installation a console is provided at a safe distance from the saw. The console is preferably situated in a demarcated safety zone. The console has a control panel for operating the sawing installation. The sawing is almost completely automated via the control panel. The length measurement of the section part to be sawn off and the possible angling of the front end face thereof can be input in the control panel. Depending on said input, the appropriate saw cut can be determined. The pusher carriage moves the structural steel section along the zero line determined by the stop to the corresponding position below the saw. The saw then saws off the desired section part, possibly at an angle.

At the end of the sawing bench facing away from the feed track there is, for example, a discharge track. In the case of sawn-off section parts that are relatively long, i.e. the front end of the structural steel section is lying on the discharge track, removal of the sawn-off product is simple. The discharge track is, for example, a driven conveyor track or roller conveyor. If, however, the length of the sawn-off section part essentially corresponds to or is even less than that of the sawing bench, the operator has to remove the short section part manually from the sawing bench. After all, the sawing bench is a “dead” zone. The sawing bench does not have a drive mechanism by means of which the sawn-off section part can be moved in a controlled manner.

If the pusher carriage pushes against the rear end of the structural steel section after said structural steel section has been sawn through, the remaining structural steel section being fed over the feed track will push with its front end against the sawn-off material. However, the path of the structural steel section fed in and the sawn-off material will almost always deviate here from the rectilinear path along the stop. In the case of angled cutting in particular, transverse shifting of the sawn-off part and the structural steel section fed in occurs. Relatively thin structural steel sections that are resting on the narrow side also give rise to uncontrolled movements during the pushing by the pusher carriage.

In practice, sawing off such short section parts is often necessary. First of all, the end face of the commercially-available structural steel section of standard length cannot be used. This end face first has to be “cleaned up”, which produces an offcut. In order to minimise material loss, the offcut has the shortest possible length. The offcut therefore always has to be removed manually. Besides, the steel constructor often needs sawn-off products of such short length, for example for construction applications.

Although the operation of the sawing installation is virtually fully automated, the necessity for manual removal of the offcut and short sawn-off products leads to a delay, which increases operational costs. Furthermore, this manual removal will adversely affect the safety of the operating staff.

The object of the invention is to provide a sawing installation, the automated operation of which is improved.

This object aim is achieved according to the invention in that the sawing installation is provided with a guide member that can move between a stowed position, in which the guide member permits unimpeded movement of the saw blade between the initial position and the final position thereof, and a guide position, in which the guide member extends essentially continuously along both sides of the sawing plane, and the guide member forms a guide channel between the stop and the guide member.

Between its initial position and its final position the saw blade of the saw delimits a sawing plane. The sawing plane is determined by the movement of the saw while the structural steel section is being sawn through. In the stowed position or rest position the guide member is moved out of said sawing plane, i.e. the guide member is moved away relative to the saw and the sawing bench in such a way that the guide member does not restrict or otherwise adversely affect the movement of the saw. In the stowed position of the guide member the saw can move unimpeded from the initial position to the final position. The guide member is situated in the stowed position during sawing.

After the structural steel section has been sawn through, the guide member moves to the guide position in order to form the guide channel. Owing to the fact that the guide member is essentially continuous during the pushing-out process, the guide channel has no lateral opening on the sawing bench. The guide member in the guide position forms a guide channel which extends essentially continuously at the location of the sawing plane.

After a part of the structural steel section has been sawn off, the guide member limits the movement of the sawn-through parts of the object lying on the sawing bench. These parts are confined in the guide channel that has been formed between the guide member and the stop. When the pusher carriage now pushes against the rear end of the structural steel section, the shifting of said structural steel section and the product sawn therefrom remains controlled. The length of the sawn-off product is immaterial here. After all, both the structural steel section and the product sawn therefrom can move only along the path that is determined by the guide channel. Therefore a sawn-off product of relatively short length can also be automatically pushed off the “dead” sawing bench. The operator of the sawing installation according to the invention does not have to remove the short sawn-off product manually. The operation of the sawing installation according to the invention can therefore be fully automatic.

After the sawn-off product has been pushed off the sawing bench by the remaining structural steel section, the guide member moves back to the stowed position, so that a further saw cut can be carried out,

Of course, the parts of the sawing installation according to the invention can be separate parts, which are aligned with respect to one another without being connected. For example, in practice, the feed track of the sawing installation is generally not fastened to the sawing bench. After transport of the sawing installation in separate parts to an end user, the feed track and the sawing bench are aligned accurately with respect to each other, after which they are anchored in a concrete floor. The guide member according to the invention can also be a separate part that is fitted independently with respect to the other parts of the sawing installation.

It is pointed out that DE 198 11 668 discloses a sawing installation for sawing a plastic section. However, this sawing installation does not have a guide channel that is laterally closed during the pushing-out process. Situated opposite the stop of the sawing installation are two pressure strips that can be pressed against the section. These pressure strips are placed at such a distance from each other that a lateral opening exists between them. When a sawn-off product is pushed out by the remaining section there is a considerable risk of the sawn-off product moving into said opening. This makes this sawing installation unsuitable for pushing out a sawn-off part of relatively short length.

It is possible according to the invention that the guide member, at least while the sawn-through parts are being pushed out, runs essentially parallel to and at a distance from the stop in order to form the guide channel. As a result of this, the guide channel on the sawing bench has a straight form that corresponds to the elongated structural steel section.

It is preferable according to the invention that the sawing bench has a feed end and a discharge end and the guide member in its guide position extends essentially continuously as far as the discharge end, The feed end of the sawing bench faces the feed track, while the discharge end is opposite the feed end. Owing to the fact that the guide channel extends to the discharge end, the sawn-off part is laterally confined until the sawn-off part has been fully pushed off the “dead” sawing bench.

In a particularly advantageous embodiment of the invention the guide member in its guide position extends essentially continuously from the feed end to the discharge end of the sawing bench. With this arrangement the guide member in its guide position extends over the entire length of the sawing bench. The guide channel is formed over the entire “dead” sawing bench during the pushing-out process. Both sawn-through parts are guided through the guide channel during the pushing-out process.

It is possible according to the invention that the guide member in its guide position is able to be pressed against sawn-through parts of the object arranged on the sawing bench. According to this embodiment of the invention, the guide member in its guide position exerts a force on the sawn-through parts of the object on the sawing bench. These sawn-through parts are made up of the sawn-off product and the remaining structural steel section. As a result of pressing, the sawn-through parts are brought into a closely fitting position between the stop and the guide member. The force exerted in this case is so slight that the object is only weakly pinched between the stop and the guide member. The friction between the sawn-through parts, on the one hand, and the stop and the guide member, on the other hand, is relatively low. The pusher carriage can still easily push the sawn-through parts through the guide channel.

The guide member according to the invention can be implemented in various ways. The guide member is preferably in the form of at least one elongated guide strip. Said strip in its guide position extends on both sides of the sawing plane. The strip therefore forms a guide for the sawn-off product and for the structural steel section fed in.

Apart from that, the guide member can comprise several guide strips, which are, for example, mutually aligned in the longitudinal direction. In the stowed position the guide strips can then have been moved apart, so that the saw blade can move between them. In the guide position the guide strips are brought together in order to form a continuous guide member on both sides of the sawing plane. The guide channel extending continuously over the sawing plane can therefore comprise several guide elements that are placed against one another.

The guide strip preferably has a guide surface that faces the stop and is essentially flat. The flat guide surface has no gaps or openings in which the edges of the sawn-through parts can become caught. This is advantageous for pushing out the sawn-off part.

In one embodiment of the invention the sawing bench comprises an endless pulling element that runs transversely relative to the stop, which pulling element is tensioned between two return elements, and the guide strip being fastened to the pulling element, so that the guide strip can be driven between the rest position and the guide position by the pulling element, and the pulling element being connected to a reciprocating drive element.

The endless pulling element can be implemented in various ways. The pulling element preferably comprises a drive chain that is tensioned between two associated sprockets. The reciprocating drive element is, for example, a piston rod of an air cylinder.

When the piston rod moves from a retracted to an extended position by actuation of the air cylinder, the endless pulling element connected to the piston rod runs in concert. As a result of this, the guide strip fastened to the pulling element moves in parallel towards the stop, which corresponds to a movement from the stowed position to the guide position. Conversely, by retracting the piston rod the guide strip moves in parallel away from the stop. When the piston rod is fully retracted, the guide strip is situated in the stowed position, in which the guide strip has been turned at least to some extent along the nearest sprocket. The guide strip is then located below the top surface of the sawing bench.

Apart from that, according to the invention the movement of the guide strip from the stowed position to the guide position can also be achieved by retracting the piston rod, in which case the movement of the guide strip from the guide position to the stowed position corresponds to the extension of the piston rod. This depends on the design of the sawing installation according to the invention.

According to the invention the sawing bench can comprise a second endless pulling element that runs transversely relative to the stop, which second pulling element is tensioned between two return members, and the pulling elements being arranged essentially mutually parallel to and at a distance from one another and the guide strip being fastened transversely to both pulling elements. The second pulling element and the two return members can likewise be in the form of a drive chain and two sprockets, respectively.

With this arrangement it is advantageous that a return element for the first pulling element and a return member for the second pulling element are fixed on a common rotary shaft. The air cylinder provides the reciprocating movement of the piston rod, which can turn the drive chain anticlockwise and clockwise around its sprockets. One of said sprockets is fixed on the one end face of the common shaft. A sprocket of the second drive chain is fitted on the opposite end face of said rotary shaft. The turning movement of the first drive chain is therefore linked to a corresponding turning movement of the second drive chain. Consequently, only one piston/cylinder assembly is needed for an accurately aligned movement of the guide strip.

In one embodiment of the invention the guide member in its stowed position is arranged below the top surface of the sawing bench. When the guide member is situated below the top surface of the sawing bench, the guide member cannot impede the saw working above the sawing bench. The guide member in the stowed position is preferably moved as far as some distance below the top surface of the sawing bench, so that the saw can saw into the sawing bench without touching the guide member. The guide member in its stowed position is stowed away so far that the saw cannot damage the guide member.

In a preferred embodiment of the invention the sawing installation is provided with a movement system for moving the guide member, which movement system comprises a first guide rail and a sliding body that is fitted on the first guide rail so that it can be slid, as well as a second guide rail that is fixed on the sliding body transversely relative to the first guide rail, the guide member being fitted on the second guide rail so that it can be slid. Such a movement system provides a so-called cross guide for the guide strip.

In that case it is possible according to the invention that the first guide rail extends essentially perpendicularly relative to the longitudinal direction of the stop. As a result of this, the guide strip can be moved in the transverse direction relative to the zero line determined by the stop by sliding the sliding body over the first guide rail.

Furthermore, according to the invention the second guide rail can extend essentially parallel relative to the longitudinal direction of the stop. The guide strip can then be moved in the longitudinal direction relative to the zero line determined by the stop by sliding the guide strip over the second guide rail.

The movement system can comprise two drive elements for driving the sliding part over the first guide rail and the guide strip over the second guide rail, respectively. The drive elements comprise, for example, a piston rod and an air cylinder, which are possibly integrated with the sliding part and the guide strip, respectively.

The object must be secured during the sawing operation. For that reason, the sawing installation according to the invention usually comprises a pressure member, which during sawing, when an object has been arranged on the sawing bench, can be pressed against said object to secure it. The pressure member is known per se. The pressure member is, for example, pretensioned against the object by a spring means, as a result of which during sawing the object is clamped between the pressure member and the stop. The pressure member does not form a guide channel, since the pressure member is aligned with respect to the saw. When the saw blade moves from the initial position to the final position the pressure member is situated at some distance parallel to the saw blade. Such a pressure member cannot guide the pushing out of a relatively short sawn-off part.

In one embodiment of the invention the saw can turn about an axis that runs essentially perpendicular with respect to the sawing bench. The saw in this case can saw at an angle relative to the longitudinal direction of the structural steel section. Particularly in the case of parts of the structural steel section sawn off at an angle, the controlled pushing out of said parts through the guide channel according to the invention is a considerable improvement compared with the state of the art.

The invention furthermore relates to a movement system for moving a guide member of a sawing installation such as that described above. According to the invention the movement system can be a separate device, i.e. a mechanism which is set up separately from the sawing installation. In this case the movement system according to the invention can be subsequently added to an existing sawing installation which has already been commissioned. It is, of course, also possible for the movement system to be integrated with a part of the sawing installation, such with as the feed track.

The movement system can be implemented in various ways according to the invention. The movement system comprises, for example, a first guide rail and a sliding body that is fitted on the first guide rail so that it can be slid, as well as a second guide rail that is fixed on the sliding body transversely relative to the first guide rail, the guide member being fitted on the second guide rail so that it can be slid.

The invention also relates to a method for sawing an object, such as an elongated structural steel section, comprising:

feeding the object over a feed track to a sawing bench until the object is resting at least partially on the sawing bench, the object being aligned by a stop that guides the object during the transport thereof,

sawing off a part of the object, the sawn-off part forming a discharge part and the remaining part of the object forming a feed part,

removing the sawn-off discharge part. According to the invention, during removal of the sawn-off discharge part an essentially continuous guide member is provided adjacent to the sawn-off discharge part and the feed part of the object in order to form a guide channel. The guide member runs essentially continuously along both sawn-through parts during the pushing-out process. The guide channel is laterally closed at the location of the surfaces of the sawn-through parts in contact with one another. After this, said parts can be pushed out through the guide channel, i.e. the feed part is pushed through the guide channel, with the result that the discharge part is pushed out.

With this arrangement it is preferable that after removal of the sawn-off discharge part the guide member is removed in such a way that the saw can saw through the object without touching the guide member.

The invention will now be explained in more detail with reference to two illustrative embodiments shown in the drawing.

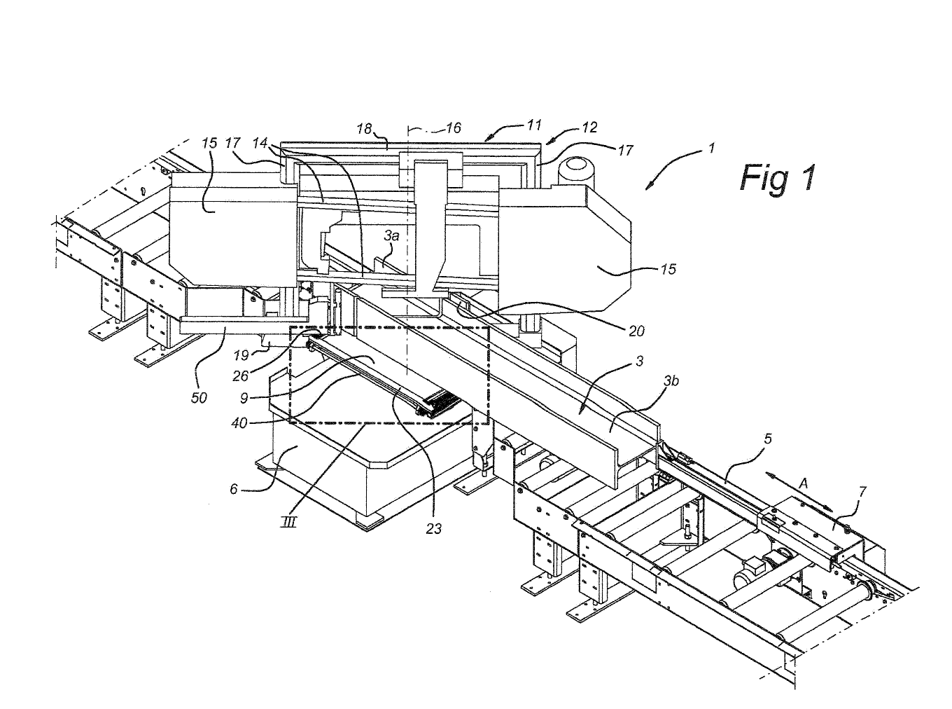

FIG. 1 shows a perspective view of a first embodiment of the sawing installation according to the invention, in which a structural steel section has been arranged and which sawing installation has been set up for sawing at an angle or mitre-sawing of said structural steel section.

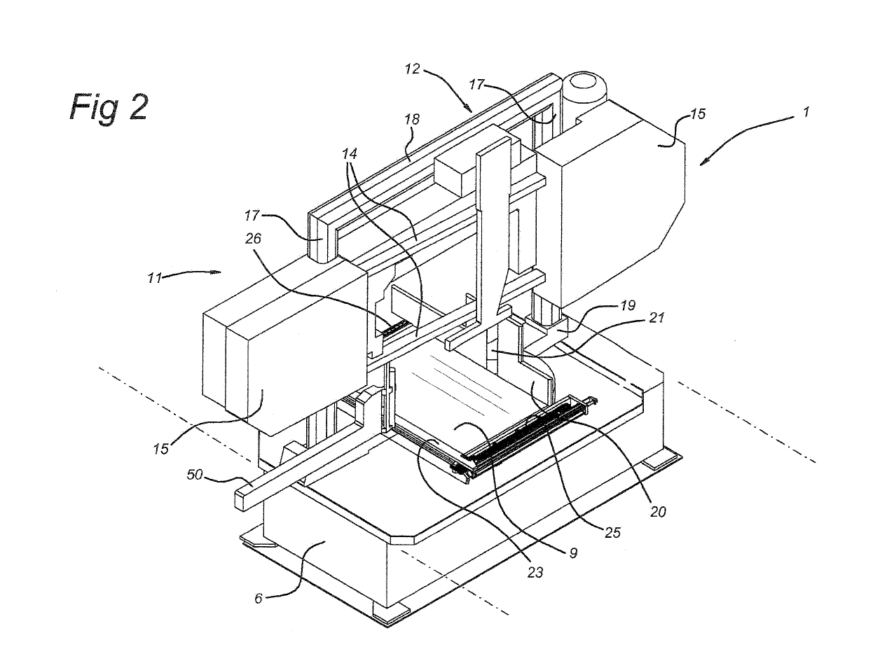

FIG. 2 shows the sawing installation shown in FIG. 1 that has been set up for straight sawing, where the feed track, the discharge track and the structural steel section have been omitted.

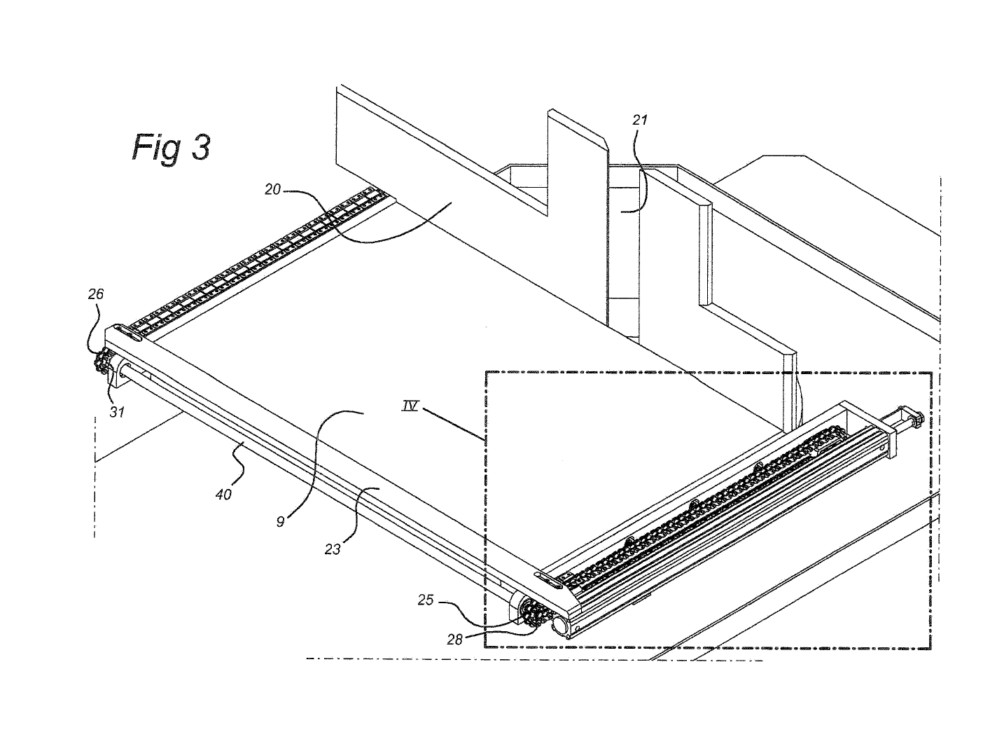

FIG. 3 shows an enlarged detail III of the sawing installation shown in FIG. 1, where the structural steel section has been omitted.

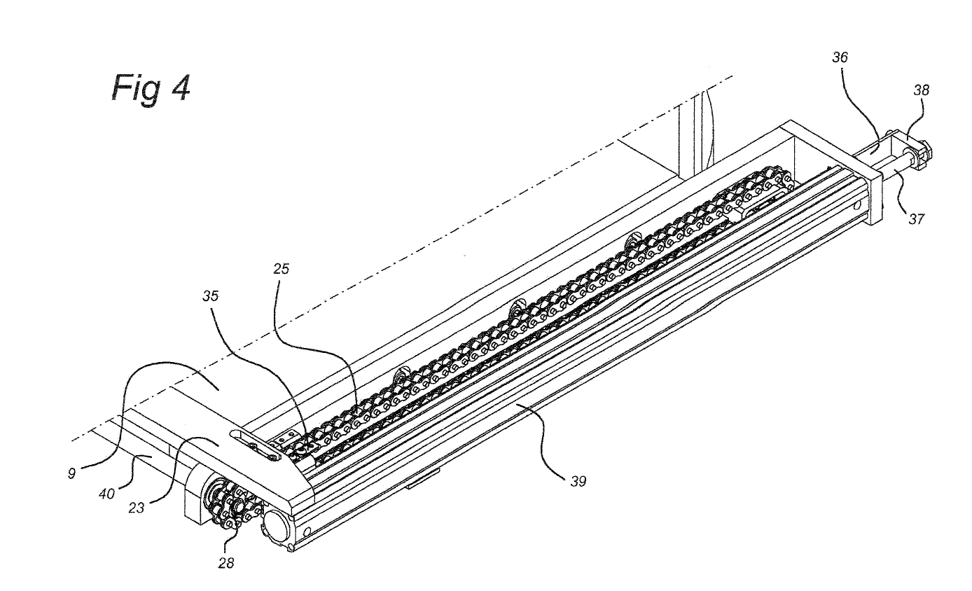

FIG. 4 shows an enlarged detail IV from FIG. 3.

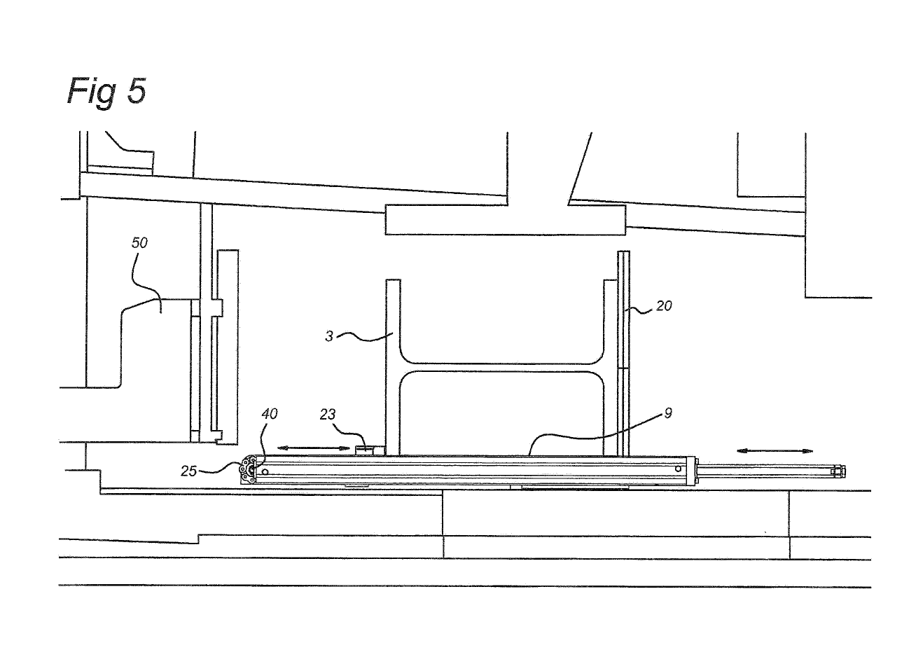

FIG. 5 shows an enlarged side view of the sawing bench, wherein the guide member is situated in the guide position.

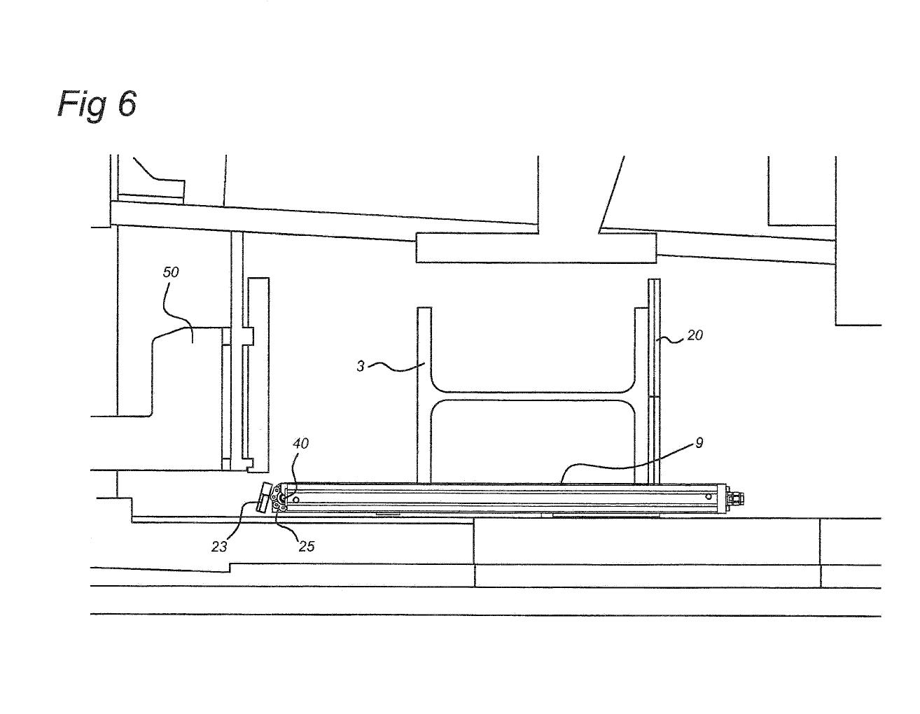

FIG. 6 shows a side view corresponding to FIG. 5, wherein the guide member is situated in the stowed position.

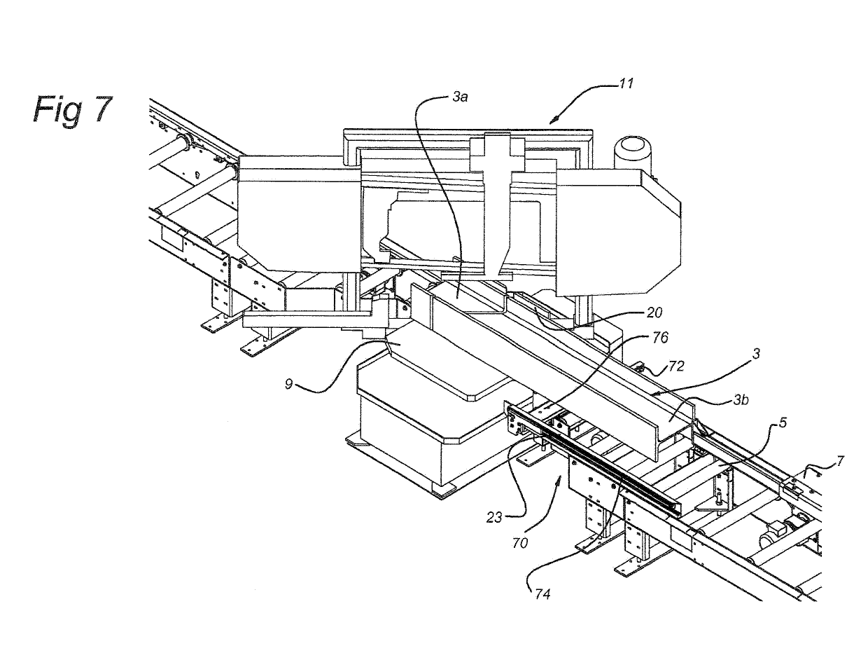

FIG. 7 shows a perspective view of a second embodiment of the sawing installation according to the invention, in which a structural steel section has been arranged and wherein the guide member is situated in the stowed position.

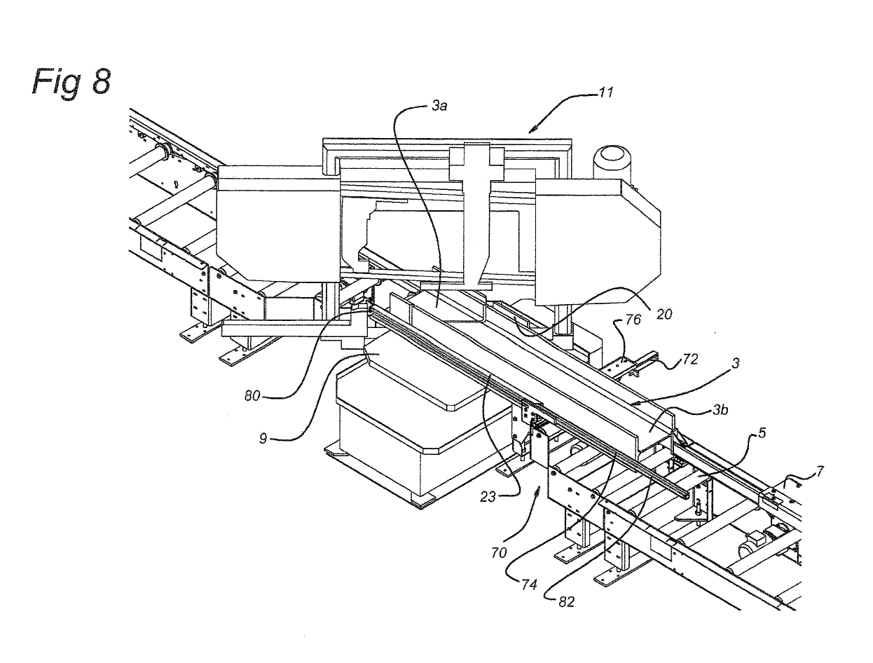

FIG. 8 shows a perspective view of the sawing installation shown in FIG. 7, in which the guide member is situated in the guide position.

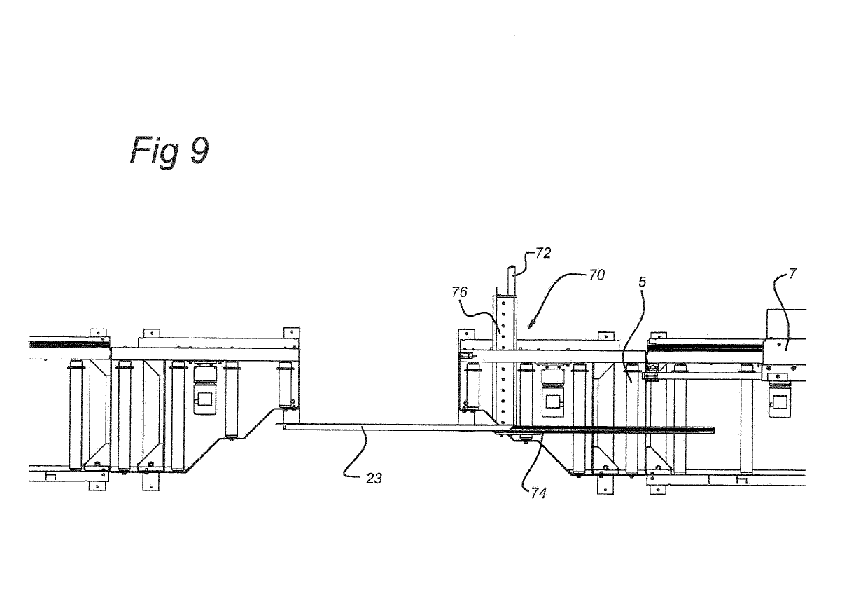

FIG. 9 shows a top view of the sawing installation shown in FIG. 7, where the sawing bench, the saw and the structural steel section have been omitted.

The first embodiment of the sawing installation according to the invention shown in FIG. 1 is indicated in its entirety by 1. The sawing installation 1 can saw any object. However, the sawing installation 1 is in particular intended for sawing elongated structural steel sections, which are commercially only available in standard lengths of 6, 12 or 24 metres. The structural steel sections can be, for example, H-shaped, U-shaped or L-shaped girders. The drawing shows an H-girder 3.

The sawing installation 1 constitutes a modular device of several parts. The sawing installation 1 comprises a feed track 5 for feeding in the structural steel section 3. The feed track 5 is a roller conveyor in this illustrative embodiment. The feed track 5 has a pusher carriage 7, which can be driven in the longitudinal direction of the feed track, which is indicated by an arrow A. During operation, the pusher carriage 7 can push against the rear end of the elongated structural steel section 3. In doing so, the pusher carriage 7 moves the structural steel section 3 in the longitudinal direction or direction of transport A.

The sawing installation 1 further comprises a sawing bench or sawing table 9, which is aligned with respect to the feed track 5. The sawing bench 9 and the feed track 5 are anchored relative to each other via the concrete floor. The pushing of the structural steel section 3 by the pusher carriage 7 results in a portion of the structural steel section 3 coming to rest on the sawing bench 9.

A stop or fixed guide 20 is fixed on the sawing bench 9. The stop is visible particularly in FIGS. 2, 3, 5 and 6. The stop 20 projects relative to the top surface of the sawing bench 9. The stop 20 is aligned in the longitudinal direction A. While the structural steel section 3 is being moved over the feed track 5 and the sawing bench 9, the stop 20 forms a reference line or zero line. The positioning of the structural steel section 3 is measured relative to said zero line. There is a vertical slit 21 in the stop 20. In this illustrative embodiment the stop 20 extends over the sawing bench 9 only, but the stop 20 can, for example, also extend over the feed track and the sawing bench (not shown).

The sawing installation 1 further comprises a trestle 6, by means of which the sawing installation rests stably on a substrate during sawing. The sawing bench 9 is firmly fixed on the trestle 6. Above the sawing bench 9 is a saw 11, which is provided with a saw frame 12. The saw frame 12 has two upright posts 17, as well as a top beam 18 and a bottom beam 19. The bottom beam 19 runs underneath the sawing bench 9.

The saw frame 12 can turn relative to the sawing bench 9 about a vertical axis 16. For this purpose, the bottom beam 19 of the saw frame 12 is connected to the trestle 6 of the sawing installation 1 so that it can pivot. The saw 11 can therefore be set at an angle relative to the structural steel section 3 on the sawing bench 9. This enables the saw 11 to saw through the structural steel section 3 at an angle.

In this illustrative embodiment the saw 11 is provided with a band saw (not shown), which is guided along a circular band guide 14. The band guide 14 is shielded by protective hoods 15 at its return ends. The band guide 14 and the band saw can be moved transversely relative to the sawing bench 9, i.e. can be moved in height along the upright posts 17 of the frame 12. The band saw can therefore move up and down vertically. During operation, the band saw constitutes a saw blade that saws through the structural steel section 3.

In FIG. 1 the saw 11 is set for sawing of the structural steel section 3 at an angle. FIG. 2 shows the position of the saw 11 for straight sawing of the structural steel section 3. For the sake of clarity of the drawing, the structural steel section is omitted in this case. The saw 11 is turned slightly about the vertical axis 16 compared with the position shown in FIG. 1, so that the saw 11 is aligned essentially straight relative to the longitudinal direction A of the structural steel section 3.

The sawing installation 1 furthermore has a pressure member 50, which is pressed against the structural steel section 3 during sawing. The pressure member 50 secures the structural steel section 3 during sawing, so that the structural steel section 3 cannot shift as a result of the forces exerted by the saw 11.

During sawing the band saw performs a sawing movement that is guided by the band guide 14. At the same time the band saw is pressed downwards from an initial position above the structural steel section 3 to be sawn. In order to ensure that the structural steel section 3 is completely sawn through, the band saw saws slightly into the sawing bench 9. The band saw has then reached a final position in which the sawn-off part of the structural steel section is guaranteed to have come away from the remaining structural steel section.

The sawn-off part of the structural steel section constitutes a discharge part 3a, while the remaining part of the structural steel section constitutes a feed part 3b. The discharge part 3a must be removed from the sawing bench 9. The feed part 3b usually constitutes a shortened structural steel section, a part of which is sawn off again.

When the pusher carriage 7 pushes against the rear end of the feed part 3b, the feed part 3b will push the discharge part 3a off the sawing bench 9. Since the saw cut carried out according to FIG. 1 runs at an angle relative to the direction of transport A, the sawn-through parts in contact with one another exert forces on one another that have a component in the transverse direction. As a result of this transverse component as a result of the angled saw cut shown in FIG. 1, the feed part 3b, viewed in the direction of transport A, has the tendency to be deflected to the left. The feed part 3b would then no longer be aligned along the stop 20. Because of the transverse component, the discharge part 3a experiences a clockwise tilting moment.

According to the invention, a deviation from the direction of transport A is impossible because the sawing installation 1 is provided with a guide member 23 for forming a guide channel in which the sawn-through parts 3a, 3b are confined. The guide member in this illustrative embodiment is in the form of a guide strip 23, which during the pushing-out process is located on both sides of the sawing plane parallel to the stop. The guide strip 23 is therefore in a position adjacent to the discharge part 3a and the feed part 3b. Moreover, the guide member 23 preferably extends along the entire length dimension, running in the direction of transport A, of the sawing bench 9. As a result of this, the two sawn-through parts 3a, 3b can be pushed out over the entire “dead” zone of the sawing bench.

The guide strip 23 according to this illustrative embodiment can move between a guide position shown in FIG. 5 and a stowed position shown in FIG. 6. In the guide position the guide strip 23 and the stop 20 form between them the guide channel for accommodating the sawn-through parts. In the stowed position the guide strip is moved away from the working area of the saw.

Owing to the fact that according to this illustrative embodiment the guide strip 23 can move, the width of the guide channel can vary. The width of the guide channel can be set. The movable guide strip 23 can be positioned in such a way that the guide channel corresponds to the width of the structural steel section 3. The movable guide strip 23 can therefore guide structural steel sections of different width sizes. The sawing installation 1 according to this illustrative embodiment is versatile in use,

For the drive of the movable guide strip 23 of the illustrative embodiment shown in the drawing, the sawing installation 1 has a chain drive, which is shown in detail in FIGS. 3 and 4. The chain drive in this illustrative embodiment comprises two endless chains 25, 26 that are each tensioned between two sprockets.

The first chain 25 is accommodated between the sawing bench 9 and feed track 5 situated in the extension of one another, i.e. at the feed end of the sawing bench 9. The endless chain 25 has a catch 35, which is connected via a connecting strip 36 to a piston/cylinder assembly that comprises a piston rod 37 and an air cylinder 39. The piston rod 37 is connected at its head end by means of a transverse stay 38 to an end of the connecting strip 36. The opposite end of the connecting strip 36 is fixed to the catch 35. During the stroke of the piston rod 37 from the retracted position to the extended position, the catch 35 remains between the sprockets of the first chain 25. The part of the chain 25 situated along the catch 35 therefore does not move past these sprockets.

The second chain 26 is accommodated at the discharge end of the sawing bench 9. The sprocket 28 of the first chain 25 and the sprocket 31 of the second chain 26 arc fixed on the end faces of a common rotary shaft 40. The second chain 26 can therefore be driven via the sprocket 28, the common rotary shaft 40 and the sprocket 31.

The guide strip 23 is connected to both chains 25, 26. With this arrangement the guide strip 23 is situated parallel to the stop 20. The guide strip 23 is connected to the first chain 25 in such a way relative to the catch 35 that the guide strip 23 is in the stowed position shown in FIG. 6 when the piston rod 37 is fully retracted. In this case the guide strip 23 is located slightly below the top surface of the sawing bench 9. The band saw of the saw 11 can consequently in the final position saw into the sawing bench 9 without damaging the guide strip 23.

When the piston rod 37 is extended the guide strip 23 forms the guide channel together with the stop 20. The distance over which the piston rod 37 is extended determines the width of the guide channel. The maximum travel of the piston rod 37 is sufficiently great, i.e. even the narrowest structural steel sections commercially available can be confined in a closely fitting manner between the stop 20 and the guide strip 23.

Of course, it is possible to effect the drive of the guide strip 23 in alternative ways. For example, the chains 25, 26 can be replaced by drive belts that are each tensioned between two return rollers (not shown). Furthermore, the piston/cylinder assembly can be provided in a different position with respect to the sawing bench 9.

The operation of the sawing installation 1 according to this illustrative embodiment of the invention is as follows. First, the saw 11 is situated in the raised initial position and the guide strip 23 is out of the way in the stowed position. Then a structural steel section 3 of a commercial length is loaded onto the feed track 5. The front end face of said structural steel section 3 has to be “cleaned up”, which produces an offcut. With regard to the desired section part after cleaning up, sawing off the front end face at an angle, for example, is necessary. For this the operator of the sawing installation 1 will enter in a control unit, such as a computer, a minimum required length for the offcut to be sawn off and the desired angle.

The computer subsequently controls the pusher carriage 7 in such a way that the pusher carriage 7 moves the structural steel section 3 over the feed track 5 according to direction of transport A towards the sawing bench 9 until the set position has been reached.

1. Sawing installation (1) for sawing an object (3), such as an elongated structural steel section, comprising:
a sawing bench (9) for at least partially accommodating the object (3),
a saw (11) that comprises a saw blade, which saw blade (11) can move transversely relative to the sawing bench (9) in a sawing plane between an initial position in which, when an object (3) has been arranged on the sawing bench (9), the saw blade is situated at a distance therefrom, and a final position, wherein the saw blade has sawn through said object (3),
a feed track (5) that is aligned with respect to the sawing bench (9), which feed track (5) is provided with a drive member (7) for driving the object (3) over the feed track (5) towards the sawing bench (9), as well as
a stop (20) for guiding the object (3) while it is being driven,
characterised in that the sawing installation (1) is provided with a guide member (23) that can move between a stowed position, in which the guide member (23) permits unimpeded movement of the saw blade between the initial position and the final position thereof, and a guide position, in which the guide member (23) extends essentially continuously along both sides of the sawing plane, and the guide member (23) forms a guide channel between the stop (20) and the guide member (23).

2. Sawing installation according to claim 1, wherein the guide member (23) in its guide position extends essentially parallel to and at a distance from the stop (20).

3. Sawing installation according to claim 1 or 2, wherein the sawing bench (9) has a feed end and a discharge end and wherein the guide member (23) in its guide position extends essentially continuously as far as the discharge end.

4. Sawing installation according to claim 3, wherein the guide member (23) in its guide position extends essentially continuously from the feed end to the discharge end of the sawing bench (9).

5. Sawing installation according to one of the preceding claims, wherein the guide member (23) in its guide position can be pressed against sawn-through parts of the object (3) arranged on the sawing bench (9).

6. Sawing installation according to one of the preceding claims, wherein the guide member is provided with an elongated guide strip (23).

7. Sawing installation according to claim 6, wherein the guide strip (23) has a guide surface that faces the stop (20) and is essentially flat.

8. Sawing installation according to claim 6 or 7, wherein the sawing bench (9) comprises an endless pulling element (25) that runs transversely relative to the stop (20), which pulling element (25) is tensioned between two return elements (28, 29), and the guide strip (23) being fastened to the pulling element (25), so that the guide strip (23) can be driven between the stowed position and the guide position by the pulling element (25), and the pulling element (25) being connected to a reciprocating drive element (37, 39).

9. Sawing installation according to claim 8, wherein the drive element comprises a piston rod (37) and an air cylinder (39).

10. Sawing installation according to claim 8 or 9, wherein the sawing bench (9) comprises a second endless pulling element (26) that runs transversely relative to the stop (20), which second pulling element (26) is tensioned between two return members (31, 32), and the pulling elements (25, 26) being arranged essentially mutually parallel to and at a distance from one another, and the guide strip (23) being fastened transversely to both pulling elements (25, 26).

11. Sawing installation according to claim 10, wherein a return element (28) for the first pulling element (25) and a return member (31) for the second pulling element (26) are fixed on a common rotary shaft (40).

12. Sawing installation according to one of the preceding claims, wherein the guide member (23) in its stowed position is arranged below the top surface of the sawing bench.

13. Sawing installation according to one of claims 1-7, wherein the sawing installation (1) is provided with a movement system (70) for moving the guide member (23), comprising a first guide rail (72) and a sliding body (76) that is fitted on the first guide rail (72) so that it can be slid, as well as a second guide rail (74) that is fixed on the sliding body (76) transversely relative to the first guide rail (72), the guide member (23) being fitted on the second guide rail (74) so that it can be slid.

14. Sawing installation according to claim 13, wherein the first guide rail (72) extends essentially perpendicularly relative to the longitudinal direction of the stop (20).

15. Sawing installation according to claim 13 or 14, wherein the second guide rail (74) extends essentially parallel relative to the longitudinal direction of the stop (20).

16. Sawing installation according to one of the preceding claims, wherein a pressure member (50) is provided that during sawing, when an object (3) has been arranged on the sawing bench (9), can be pressed against said object (3) to secure it.

17. Sawing installation according to one of the preceding claims, wherein the saw (11) can turn about an axis (16) that runs essentially perpendicular with respect to the sawing bench (9).

18. Movement system for moving a guide member (23) of a sawing installation according to one of the preceding claims.

19. Movement system according to claim 18, comprising a first guide rail (72) and a sliding body (76) that is fitted on the first guide rail (72) so that it can be slid, as well as a second guide rail (74) that is fixed on the sliding body (76) transversely relative to the first guide rail (72), the guide member (23) being fitted on the second guide rail (74) so that it can be slid.

20. Method for sawing an object (3), such as an elongated structural steel section, comprising:
feeding the object (3) over a feed track (5) to a sawing bench (9) until the object (3) is resting at least partially on the sawing bench (9), the object (3) being aligned by a stop (20) that guides the object (3),
sawing off apart of the object (3), the sawn-off part forming a discharge part and the remaining part of the object forming a feed part,
removing the sawn-off discharge part,
characterised in that during removal of the sawn-off discharge part (3a) an essentially continuous guide member (23) is provided adjacent to the sawn-off discharge part (3a) and the feed part (3b) of the object (3) in order to form a guide channel.

21. Method according to claim 20, wherein said sawn-off discharge part (3a) is pushed out through the guide channel by the feed part (3b).

22. Method according to claim 20 or 21, wherein after removal of the sawn-off discharge part the guide member (23) is removed in such a way that the saw (11) can saw through the object without touching the guide member (23).
